(19) United States
(12) Patent Application Publication
(10) Pub. No.: US 2015/0090655 A1
(43) Pub. Date: Apr. 2, 2015

(54) FILTRATION ASSEMBLY WITH BACKWASHING FOR PRESSURIZED FLUID SYSTEM

(71) Applicants: Christopher Scott Rau, Battle Creek, MI (US); Michael Roland Clements, White Pigeon, MI (US); Jason Robert Swinehart, Portage, MI (US); Michael Edward Isch, Vicksburg, MI (US); David Lee Truman, Marcellus, MI (US)

(72) Inventors: Christopher Scott Rau, Battle Creek, MI (US); Michael Roland Clements, White Pigeon, MI (US); Jason Robert Swinehart, Portage, MI (US); Michael Edward Isch, Vicksburg, MI (US); David Lee Truman, Marcellus, MI (US)

(73) Assignee: EATON CORPORATION, Cleveland, OH (US)

(21) Appl. No.: 14/042,784

(22) Filed: Oct. 1, 2013

(51) Int. Cl. B01D 29/68; B01D 29/52

(52) U.S. Cl. CPC B01D 29/682; B01D 29/52
USPC 210/333.01

(57) ABSTRACT

A filtration assembly for a pressurized fluid system having a horizontally oriented tubular pressure vessel with a removable lid. A plurality of shroud tubes arranged in an inner array and a surrounding outer array receive contaminated fluid from the pressure vessel inlet through apertures in a vessel bulkhead to which the shroud tubes are attached. A plurality of tubular filter media elements with a closed end are received in each shroud tube and the opposite open end of each filter element is attached over an aperture in a cover plate sealed over the open end of the shroud tube. A tubular back wash arm has its opposite ends disposed for, upon rotation by a servo motor, being positioned progressively over selected apertures in the bulkhead for connecting the selected filter media elements to a drain for effecting backwashing.

### BACKGROUND

The present disclosure relates to a filter assembly of the type housed in a pressure vessel for providing filtering of fluid flowing in a pressurized fluid system. Such filter assemblies are employed in water treatment systems and systems employing hydraulic or other fluids in a closed system where it is necessary to remove contaminants from the fluid in order to protect the system components. Examples of such systems are those employed for filtering hydrocarbon fluids in crude oil refining where system pressures in the range of 300-600 psi and fluid temperatures of 750° F. are encountered in addition to relatively high volume flow of such fluids.

The more typical filtration systems employ generally cylindrical pressure vessels oriented with their axis of the cylinder disposed vertically requiring support structure, such as legs welded thereon, which raised the height of the vessel from the support surface or floor, thus making lid or closure removal difficult. Therefore, it has been desired to have the pressure vessel oriented with the axis of the cylindrical configuration disposed horizontally.

Heretofore, where more than one filter element was required, separate pressure vessels have been employed with provisions made for isolating the pressure vessels individually for performing regeneration of the element in the filter tube for each pressure vessel. Such arrangements require a relatively large physical layout and additional valving arrangements. This requirement for multiple pressure vessels has made such arrangements prohibitively costly and unworkable where the space available is limited.

One known technique employed for internal backwashing has employed a rotating arm with a nozzle in the form of a narrow slot on the end of an arm which can be positioned progressively at selected regions of the filter media and a suction applied through the arm to the slot to remove contaminants from a narrow band of the filter media. This technique requires a suction pump and additional complex controls and is thus costly to employ in systems requiring a high flow volume for filtration.

Another technique employed in present internal fluid filtering arrangements is that of employing a single pressure vessel with multiple filter media tubes, fluidly connected to have the interior of the tube as the upstream side, with a movable backwash tube disposed therein. The backwash tube may be moved for connecting the element tube to a drain at a substantially lower pressure than the filtrate in the vessel thus enabling backwashing by movement of the backwash tube.

External backwashing with a clean fluid separate from the fluid being filtered, which may include solvents, has been employed and has the advantage that a higher pressure may be employed to more effectively remove caked and large particle size contaminants; and, a more intense pressure pulse applied to backwashing to break loose heavy contaminants.

However, where it has been desired to provide an external source of backwashing fluid, particularly with fluid cleaner than the filtrate, such an arrangement was only possible where single filter elements were employed in each of the pressure vessels.

It has thus been desired to provide a way or means of housing a plurality of tubular filter media elements filtering flow from the exterior to the interior and in a single pressure vessel and providing for internal backwashing of the individual filter media elements by utilizing the filtered fluid in the pressure vessel for selectively individually backwashing each of the multiple filter media elements in a manner which accommodates and maintains flow through the remaining filter media elements.

### SUMMARY

The present disclosure describes and illustrates a fluid filtration assembly for filtering fluid flowing in a pressurized fluid system and utilizes a single pressure vessel which may be of cylindrical configuration for connection in the system to receive contaminated fluid at the vessel inlet and discharge filtered fluid at the outlet to continue in the system. The filtration assembly of the present disclosure describes a single pressure vessel oriented horizontally having a plurality of shroud tubes each with a plurality of tubular filter media elements or “sticks” disposed therein of the type having the exterior of the media element as the upstream side and the interior as the downstream side. One end of each shroud tube is connected to a bulkhead in the pressure vessel such that fluid from the inlet flows through an aperture in the bulkhead to the interior of the shroud tube. The opposite end of the shroud tube is sealed by a cover plate such that the interior thereof communicates exclusively through an aperture in the cover plate permitting flow of filtrate to the vessel outlet.

A rotating tubular drain arm is provided in the region of the pressure vessel between the bulkhead and a drain outlet in the pressure vessel. The tubular drain arm has a first open end disposed for, upon rotation, to be selectively and progressively positioned coincident with an aperture in the bulkhead for communicating flow to the interior of one of an inner array of the shroud tubes. A second open end of the drain arm is disposed for, upon rotation of the drain arm, to be selectively and progressively positioned coincident an aperture in the bulkhead for communicating flow to the interior of one of an outer array of shroud tubes surrounding the inner array. The apertures in the bulkhead are offset from the center of the shrouds and tangentially adjacent the inner periphery of the shrouds. A drain port in the drain arm is provided intermediate the first and second ends; and, the drain arm is disposed on a rotatable fluid coupling communicating the drain port in the drain arm with the drain port in the fluid vessel. A motor drive shaft is connected through the rotatable coupling to the rotating drain arm. Brackets are provided on the pressure vessel for supporting it in a horizontal orientation.

### BRIEF DESCRIPTION OF THE DRAWINGS

FIG. 1 is a side elevation view of the filtration assembly of the present disclosure;

FIG. 2 is a right hand end view of the assembly of FIG. 1 with the closure bolts removed;

FIG. 3 is a cross-sectional view taken along section indicating lines 3-3 of FIG. 2;

FIG. 4 is a side elevation view of the sub-assembly of the shroud tubes and bulkhead;

FIG. 5 is a right hand end view of the sub assembly of FIG. 4;

FIG. 6 is an enlarged partial section view of sub-assembly of the FIG. 4;

FIG. 7 is a side elevation view of the sub-assembly of FIG. 4 with portions broken away to show filter media elements assembled into one of the shroud tubes;

FIG. 8 is an enlarged detail of a portion of FIG. 3;

FIG. 9 is a diagram of the flow of fluid through the assembly of FIG. 1 for effecting normal fluid filtration; and,

FIG. 10 is a flow diagram of the flow through the assembly of FIG. 1 during backwashing.

### DETAILED DESCRIPTION

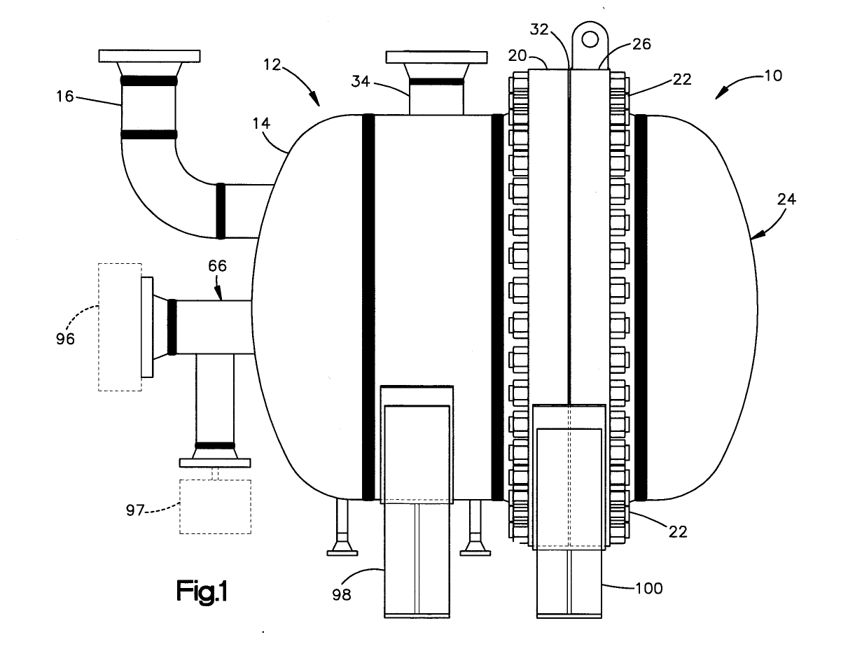

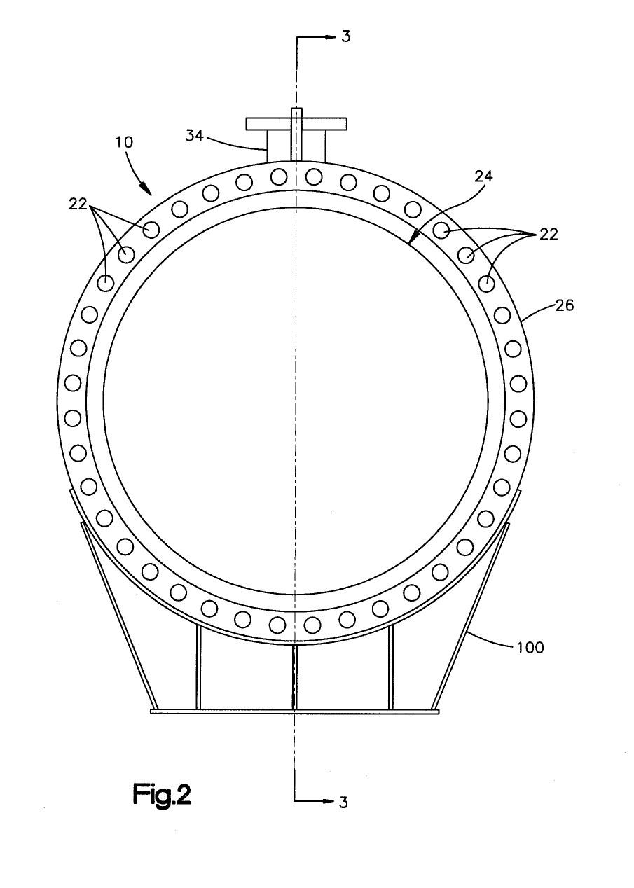

Referring to FIGS. 1-3, the filtering assembly of the present disclosure is indicated generally at 10 including a pressure vessel indicated generally at 12 having a generally cylindrical tubular configuration with a closed end 14. An inlet fitting 16 is provided thereon which defines an inlet passage or port 18 into pressure vessel 12. The open end of the pressure vessel 12 opposite end 14 has an annular rim flange 20 provided thereon which has a plurality of circumferentially spaced apertures 22 formed therein. A lid or closure indicated generally at 24 is disposed over the open end of the pressure vessel 12. The lid 24 also has an annular rim flange 26 provided thereon which has a plurality of circumferentially spaced apertures 28 formed therein which coincide with the apertures 22 in the rim flange 20. The lid 24 is removably attached over the flange 20 by a plurality of threaded fasteners such as studs or bolts 30; and, a sealing gasket 32 is provided between the rim flanges 20, 26.

An outlet fitting 34 is provided in the pressure vessel 12 and defines an outlet port or passage 36. A mounting flange 38 having an annular configuration is provided on the interior of the pressure vessel 12 between the outlet port 36 and the inlet port 18.

A bulkhead or backwash plate 40 is mounted on the annular flange 38 and removably attached thereto by suitable fasteners such as bolts 42 disposed through apertures n circumferentially spaced arrangement thereabout. The bulkhead 40 has a plurality of fluid flow apertures provided therein in an inner array which apertures are denoted by reference numeral 44; and, bulkhead 40 has an outer array of apertures 46 arranged in circumferentially spaced arrangement surrounding the inner array of apertures 44. The arrangement of the apertures is more clearly illustrated in FIG. 5.

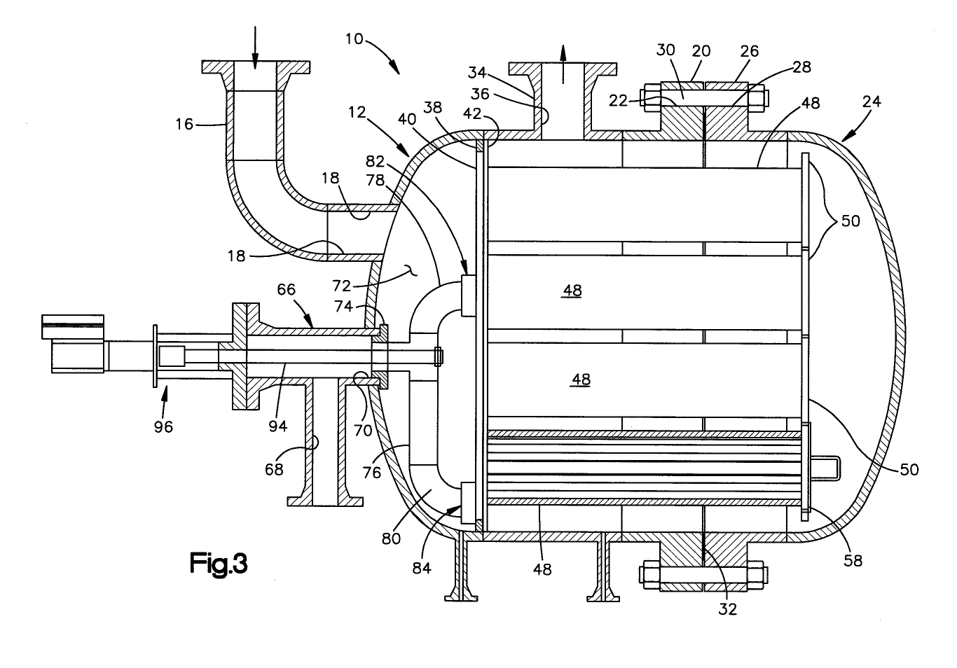

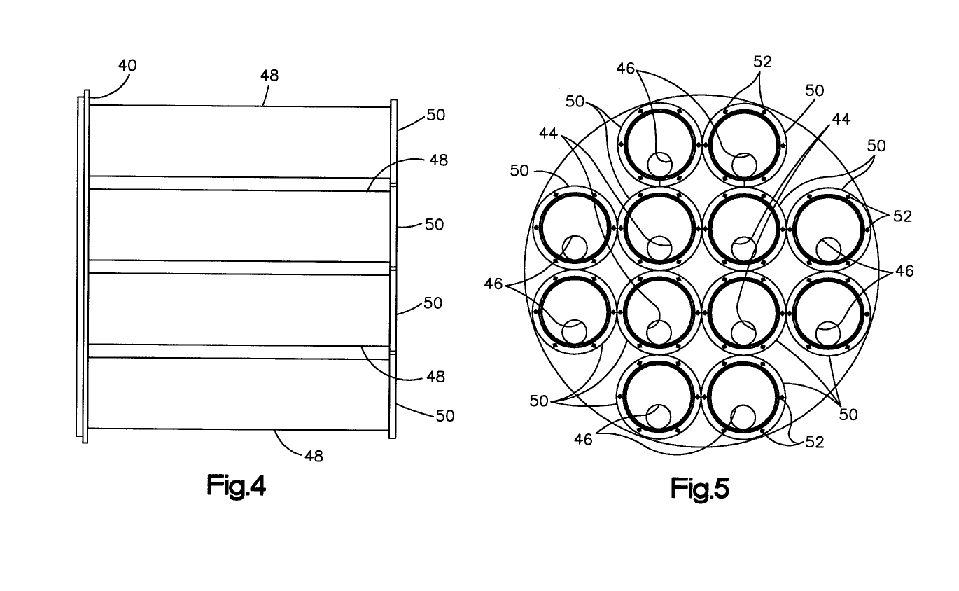

Referring to FIGS. 3, 4 and 5, a plurality of shroud tubes 48 provided each having an end thereof attached, such as by weldment, to bulkhead 40 in fluid pressure sealing arrangement with the interior of the tube disposed to communicate respectively with one of the inner array and outer array of apertures 44, 46. In the present practice, it has been found advantageous to locate the shroud tubes 48 such that the apertures 44, 46 are tangentially adjacent the inner periphery of the shroud tube, as shown in FIG. 5, as opposed to being centrally located therein. This arrangement has been found to minimize accumulation of dirt and foreign material, particularly during the backwash cycle which will be hereinafter described.

The open end of each shroud tube 48 opposite the bulkhead 40 has an annular flange or seal ring 50 attached thereto, for example, as by weldment, such that the flange 50 is sealed about the shroud tube 48.

Referring to FIG. 5, it has been found satisfactory in the present practice to hold the annular seal rings 50 to each other at the point of mutual contact for providing additional support of the shroud tubes 48.

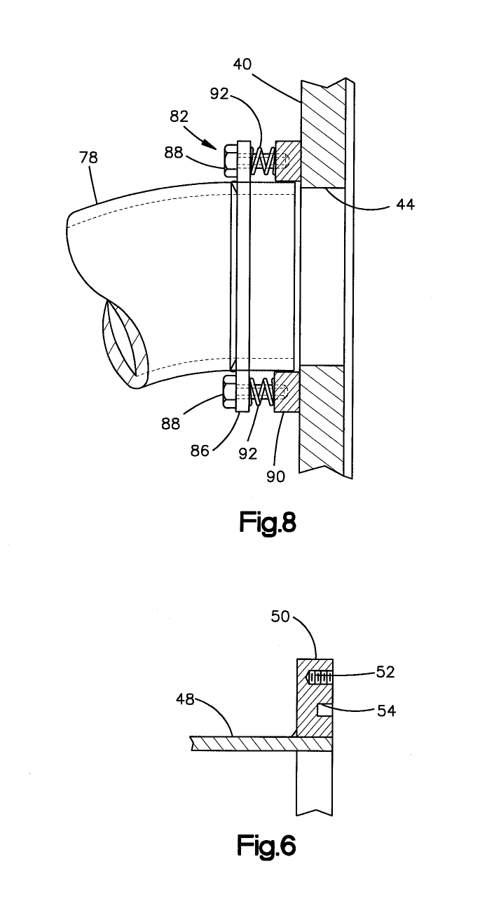

Referring to FIG. 6, each of the seal rings 50 has a plurality of circumferentially spaced tapped holes 52 formed therein. The outer face of each of the flanges 50 has an annular groove 54 formed therein located radially inwardly of the tapped holes 52. The annular groove 54 is provided for receiving a flexible seal ring, such as an O-ring (not shown), for sealing thereover as will hereinafter be described.

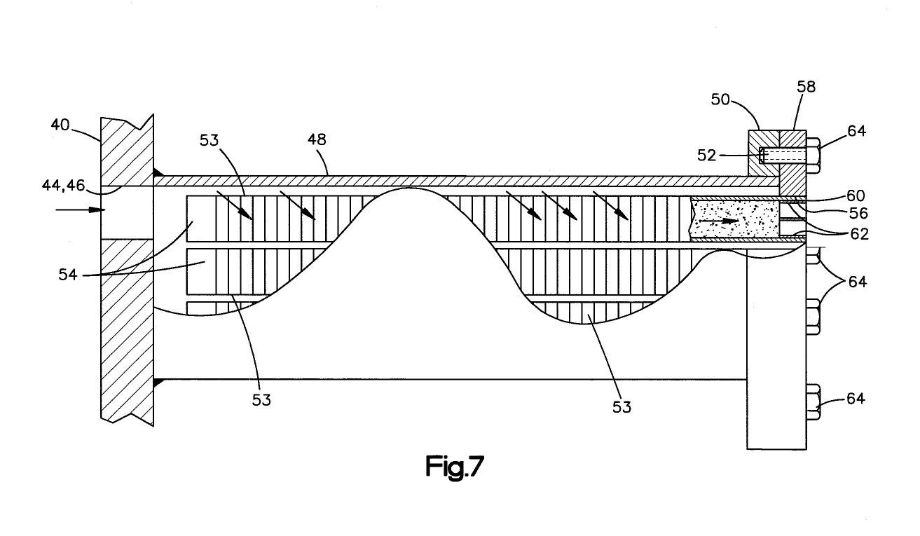

Referring to FIGS. 3 and 7, each of the shroud tubes 48 has a plurality of tubular filter media elements 53 or sticks exposed therein which comprise tubes of screen or mesh material, such as, for example, stainless steel material. Each filter media element 53 has a closed end 54. The opposite end of each filter media element is open and attached to a cover plate 58 through an aperture 56 and secured therein by an insert 60 having a plurality of apertures 62 therein. In the present practice, it has been found satisfactory to secure the insert 60 and open end of filter media element 53 to cover plate 58 by weldment. The interior of the media elements 53, thus, communicate exclusively through the aperture 60 to the exterior of the shroud tube 48; whereas, the exterior of the media filter tubes 53 communicates exclusively with the interior of the shroud tube 48. The cover plate 58 is retained over the seal ring 50 by suitable fasteners 64 engaging the tapped holes 52 and sealed thereover by a seal ring (not shown) disposed in groove 54.

Referring to FIGS. 1 and 3, a drain fitting indicated generally at 66 defines a drain port 68 communicating with a passage 70 which communicates with the interior region 72 of the pressure vessel formed by the closed end 12 and bulkhead 40. The closed end 12 has a rotary fluid coupling 74 provided therein over the end of passage 70 which coupling has attached thereto a tubular drain arm 76. The tubular arm 76 has a portion intermediate the ends thereof forming a drain port therein which is connected to the rotary coupling 74 for permitting discharge from tubular drain arm 76 into the passage 70 and drain 68. The opposite ends of the drain arm 76 are formed to be positioned respectively, upon rotation of the arm in coupling 74, coincident with the inner array of apertures 44 and the outer array of apertures 46. As shown in FIGS. 3 and 8, one end of drain arm 76, denoted by reference numeral 78, is positioned to, upon rotation of the arm 76, progressively selectively coincide with each of the apertures 44 in bulkhead 40. The opposite end 80 of arm 76 is arranged to, upon rotation of the drain arm 76, progressively selectively coincide with each of the apertures 46 in the outer array of the bulkhead. The ends of the drain arm 78, 80 each have respectively, a sealing arrangement indicated generally at 82, 84, sealing about the respective apertures 44, 46 such that the aperture communicates exclusively with the adjacent end of the drain arm.

Referring to FIG. 8, the sealing arrangement 82 is shown typically as having the end 78 of arm 76 including an annular flange 86 secured thereto by weldment. Flange 86 has a plurality of threaded fasteners provide thereabout in circumferentially spaced arrangement as denoted by reference numeral 88, each of which threadedly engages a seal ring 90 axially spaced from flange 86. The seal ring 90 is biased away from flange 86 in a direction to effect contact with the surface of the bulkhead 40 by a spring 92 disposed about each of the fasteners 88. The seal rings 90 are operative to prevent pressurized fluid in the region 72 of the pressure vessel from entering the aperture 44 or the ends 78, 80 of the drain arm. Thus, only backwash flow from the interior of the associated shroud tube 48 passes through the aperture 44 and into the drain arm during the drain cycle as will hereinafter be described.

The passage 70 has a shaft extending therethrough and through the rotary coupling 74 with an end thereof connected in driving engagement with the drain arm 76. The opposite end of the shaft 94 extends outwardly of the fitting 66 and is connected to a motor drive indicated generally at 96. Upon activation of the motor drive 96, shaft 94 is operative to rotate the arm 76 in the region 72 of the pressure vessel. As shown in FIG. 1, in dashed outline, a remotely operated valve 97 may be employed for selectively opening the drain passage 68 to a drain maintained at pressure significantly lower than the pressure of the filtered fluid in the outlet of the pressure vessel.

Referring to FIG. 1, pressure vessel 12 has a pair of support brackets 98, 100 provided thereon attached thereto such as by weldment for supporting the pressure vessel in horizontally oriented arrangement.

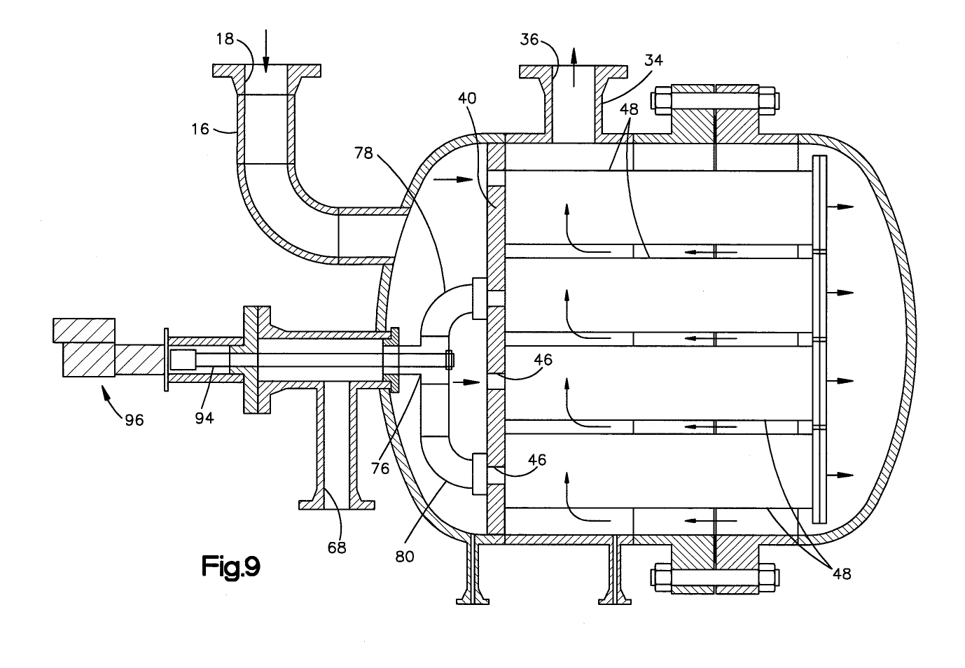

Operation of the filtering assembly is illustrated in FIG. 9 wherein fluid enters at port 18 and passes through the bulkhead apertures 44, 46 which are not covered by the ends 78, 80 of the drain arm and into the interior of the shroud tubes 48 and is filtered. Filtered fluid passes through the apertures in the cover plate 58 and flows through the spaces between the shroud tubes 48 outwardly to the outlet passage 36 as shown by the black arrows in FIG. 9.

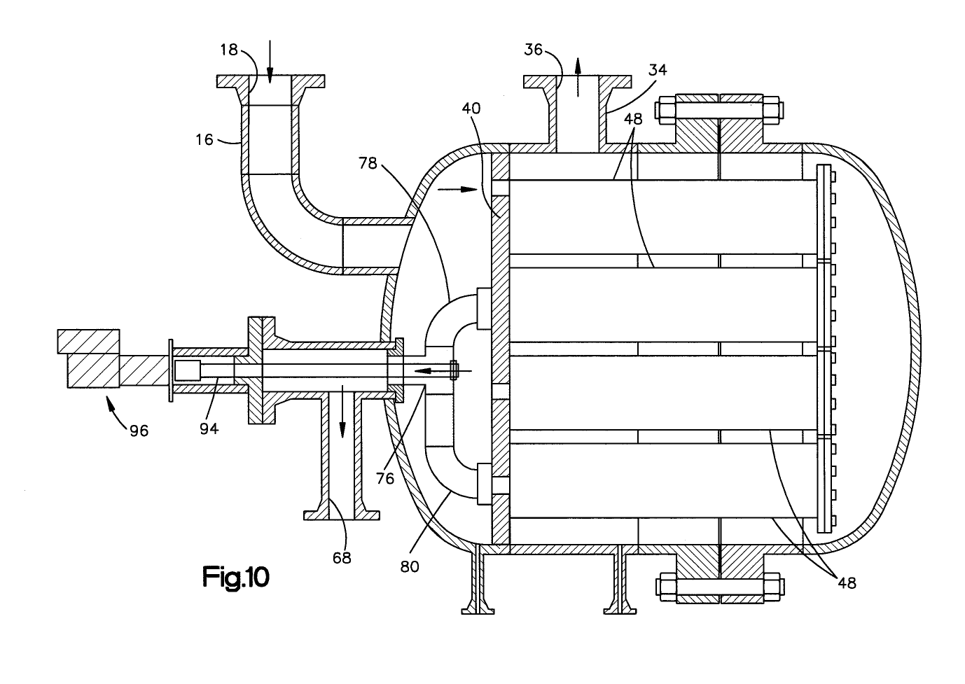

Referring to FIG. 10, flow is shown during the drain cycle mode of operation in which the ends 78, 80 of the drain tube 76 positioned over selected ones of apertures 44, 46 and which are connected to the drain passage 68 by opening of the valve 97 (see FIG. 1). The drain passage 68 is thus connected to a drain which is at a pressure significantly lower than that of the filtered fluid thus causing the pressure in the interior of the shroud tubes 48 associated with the selected apertures 44, 46 to drop such that backflow occurs through the filter media sticks 53 and debris and foreign materials accumulated on the filter media sticks is backwashed or flushed outwardly through the drain passage 68. It will be understood that during backwashing of the selected apertures 44, 46 normal filtering flow continues in the remaining filter media elements.

The present disclosure thus describes a filtering assembly in which a horizontally arranged pressure vessel includes a plurality of filter media elements disposed circumferentially spaced in an inner array and an outer array surrounding the inner array. A rotatable drain arm is positioned over a rotary fluid coupling connected to a drain outlet such that, upon rotation by a servo motor, the ends of the drain arm are positioned to coincide with apertures through a bulkhead plate in the vessel to communicate with selected filter media elements in the inner array and outer array. The selected filter media elements are connected through the drain arm to a drain to effect backwashing of the selected filter media elements. A shaft through the outlet port is connected to a servo motor and to the drain arm to effect rotation of the drain arm. The filter media elements are disposed in tubular shrouds having one end welded to the vessel bulkhead with a cover plate over the opposite end. Filtered fluid from the filter media elements flows through apertures in the cover plate over the end of the shroud tube to the vessel outlet port. The filter media elements are disposed such that, upon removal of the vessel closure or lid, the filter media elements may be removed from the tubular shrouds for replacement. The filtering assembly of the present disclosure thus provides for backwashing selected filter media elements in an inner array and an outer array while maintaining filtering flow in the remaining filter media elements.

Obviously, modifications and alterations will occur to others upon reading and understanding the preceding detailed description. It is intended that the disclosed versions be construed as including all such modifications and alterations insofar as they come within the scope of the appended claims or the equivalents thereof.

1. A filtration assembly for a pressurized fluid system comprising:
(a) a pressure vessel having a generally cylindrical wall having a closed end and an open end with a removable closure/lid disposed over the open end for forming a fluid pressure chamber in the vessel;
(b) an inlet port to the chamber provided in the closed end adapted for receiving therethrough fluid to be filtered;
(c) an outlet port to the chamber provided in the cylindrical wall for discharging filtrate;
(d) a bulkhead disposed in the chamber intermediate the inlet port and outlet port, the bulkhead removably attached to the cylindrical wall and having an inner array of circumferentially spaced apertures therein and an outer array of circumferentially spaced apertures surrounding the inner array;
(e) a drain port formed in the closed end of the vessel;
(f) a tubular backwash arm disposed for rotation in the chamber intermediate the bulkhead and the drain port, the backwash arm having a first open end disposed for, upon rotation of the drain arm, selectively communicating progressively exclusively with each of the apertures in the inner array and a second open end opposite the first open end disposed for, upon rotation of the drain arm, selectively communicating progressively exclusively with each of the apertures in the outer array, the drain arm having a port therein intermediate the first and second ends thereof communicating exclusively with the drain port;
(g) a motor including a shaft operatively connected through the drain port for effecting, upon selective actuation, rotation of the tubular drain arm;
(h) a plurality of shroud tubes each having one end thereof sealingly attached over one of the apertures in the inner and outer array and an end of each shroud tube opposite the one end having a seal ring attached thereto;
(i) a filter media element attached on one end thereof to a cover plate and disposed in each one of the shroud tubes with the cover plate sealed over the seal ring and with the downstream side of each filter media element communicating exclusively through an aperture in the cover plate, wherein the upstream side of each filter media element communicates exclusively with the interior of the respective shroud tube.

2. The assembly of claim 1, where each of the seal rings is attached to an adjacent seal ring for supporting the ends of the shroud tubes.

3. The assembly of claim 1, wherein, upon removal of the closure/lid, each of the annular flanges and filter media elements is removable from the respective shroud tube.

4. The assembly of claim 1, wherein each of the shroud tubes is offset from the respective aperture in the bulkhead and tangentially aligned with the inner periphery of the shroud tube at the lowest point thereof.

5. The assembly of claim 1, wherein the drain port is formed in a fitting surrounding the shaft.

6. The assembly of claim 1, further comprising a pair of support frames attached to the cylindrical wall for supporting the tubular shelf in horizontal orientation.

7. The assembly of claim 1, wherein the filter media element includes a plurality of filter tubes attached to the cover plate in the interior of each filter tube communicating through an aperture in the cover plate.

8. The assembly of claim 7, wherein the end of each filter tube distal the cover plate is closed.

9. The assembly of claim 1, wherein the cover plate is removably sealed over the seal ring.

10. The assembly of claim 1, wherein the port in the backwash arm is disposed for communicating with the drain port through a rotatable coupling.

11. The assembly of claim 10, wherein the shaft extends through the rotatable coupling.

12. The assembly of claim 1, wherein each of the seal rings has an annular sealing groove therein for receiving an O-ring seal.

13. The assembly of claim 1, wherein the cover plate is attached to the seal ring with threaded fasteners.

14. The assembly defined in claim 1, wherein the drain port is connected to a remotely operated valve.

15. The assembly of claim 14, wherein the valve is normally closed operative upon actuator to connect the drain port drain at a pressure substantially lower than the pressure outlet port to the chamber.

16. The assembly of claim 1, wherein the first and second open ends of the drain arm include seal members sliding on a surface of the bulkhead.

17. The assembly of claim 16, wherein the seal members are spring biased against the surface of the bulkhead.
